(19) United States
(12) Patent Application Publication
(10) Pub. No.: US 2013/0100694 A1
(43) Pub. Date: Apr. 25, 2013

(54) LED Backlight Module

(71) Applicant: Tsan-Jung Chen, New Taipei City (TW)

(72) Inventor: Tsan-Jung Chen, New Taipei City (TW)

(73) Assignee: KOCAM INTERNATIONAL CO., LTD., New Taipei City (TW)

(21) Appl. No.: 13/280,335

(22) Filed: Oct. 24, 2011

(51) Int. Cl. G09F 13/04

(52) U.S. Cl. 362/602

(57) ABSTRACT

The present invention relates to an improved LED backlight module, which is disposed on a main frame installed in a liquid crystal display device, and comprises: a supporting body, a copper circuit layer, a plurality of LED chips, a plurality of extended thermal-conductivity layers, a light guide plate, and a bottom reflecting member. In the present invention, it mainly connects the plurality of extended thermal-conductivity layers to a plurality of the soldering points of the copper circuit layer, and attaches a majority of the extended thermal-conductivity layers to the surface of the bottom plate of the main frame through an insulating and thermal-conductivity adhesive; So that, when the LED chips emit the light, the soldering points conduct the heat produced by the LED chips to the extended thermal-conductivity layers, so as to evenly distribute the heat over the surface of the bottom plate through the extended thermal-conductivity layers.

### BACKGROUND OF THE INVENTION

1. Technical Field

The present invention relates to a backlight module, and more particularly, to an improved backlight module having a plurality of extended thermal-conductivity layers for helping in evenly distributing the heat over the surface of the bottom plate.

2. Description of Related Art

Recently, light-emitting diode (LED) is widely applied in illumination apparatuses. Because LED would get very hot when it is emitting, a conventional LED illumination apparatus commonly includes radiation materials or heat-dissipating device.

Please refer to FIG. 1, which illustrates a side view of a conventional LED backlight module. As shown in FIG. 1, the conventional LED backlight module 200′ is installed in a liquid crystal display device and disposed on a main frame 2′, wherein the LED backlight module 200′ includes a light guide plate 210′, a light source assembly 220′, a housing 230′, and a top frame 240′. The light source assembly 220′ consists of a circuit board 222′ and a plurality of LED chips 224′ disposed on the surface of the circuit board 222′. Besides, the LED backlight module 200′ further includes a reflector 212′ used for increasing the light utilization efficiency.

The aforesaid LED backlight module 200′ has two advantages: (1) simple structure; and (2) easy to be installed in the main frame. Thus, the LED backlight module 200′ is widely applied in various liquid crystal display devices for providing the backlight to the light guide plate. However, with the change in user habits, it is requested to be manufactured as a thin liquid crystal display device regardless of the large-sized liquid crystal display device or the small-sized liquid crystal display device. However, for the LED backlight module applied in the thin liquid crystal display device, it must face a great challenge, i.e., the complete and complex electronic circuit must be printed on a limit-sized printed circuit board.

Accordingly, for solving the great challenge, some backlight module manufactures propose the concept of folded printed circuit board, in which the complete electronic circuit is printed on a foldable printed circuit board, and then the foldable printed circuit board is folded and disposed in the housing; thus, the great challenge is be solved. However, the concept of folded printed circuit board still has two shortcomings and drawbacks: (1) the foldable printed circuit board can not be steadily disposed and fixed in the housing; and (2) the foldable printed circuit board can not completely insulated from the LED device.

Accordingly, in view of the conventional LED backlight module still has shortcomings and drawbacks, the inventor of the present application has made great efforts to make inventive research thereon and eventually provided an improved LED backlight module.

### BRIEF SUMMARY OF THE INVENTION

The first objective of the present invention is to provide an improved LED backlight module, in which a plurality of extended thermal-conductivity layers are connected to a plurality of the soldering points of a copper circuit layer, and a majority of the extended thermal-conductivity layers are further attached to the surface of the bottom plate of the main frame through an insulating and thermal-conductivity adhesive; So that, when the LED chips emit the light, the soldering points would conduct the heat produced by the LED chips to the extended thermal-conductivity layers, so as to evenly distribute the heat over the surface of the bottom plate through the extended thermal-conductivity layer.

Accordingly, to achieve the first objective of the present invention, the inventor proposes an improved LED backlight module, which is disposed on a main frame with a bottom plate, and comprises:

a supporting body, having an inner surface and an outer surface;

a copper circuit layer, attached to the inner surface of the supporting body via an insulating and thermal-conductivity adhesive, and extended to the outer surface of the supporting body, wherein the copper circuit layer comprises a plurality of main circuits, a plurality of soldering points and an electrically connecting portion ;

a plurality of LED chips, disposed on the copper circuit layer and welded to the plurality of soldering points;

a plurality of extended thermal-conductivity layers, connected with the soldering points, wherein a minority of the extended thermal-conductivity layers are attached to the inner surface of the supporting body and a majority of the extended thermal-conductivity layers are horizontally extended from the inner surface of the supporting body for being attached to the surface of the bottom plate of the main frame through the insulating and thermal-conductivity adhesive;

a light guide plate, opposite to the LED chips by a light-incident surface thereof for receiving light emitted by the LED chips; and

a bottom reflecting member, attached to the bottom surface of the light guide plate and used for preventing from the light leakage;

wherein when the LED chips emit the light, the soldering points conduct the heat produced by the LED chips to the extended thermal-conductivity layers, so as to evenly distribute the heat over the surface of the bottom plate.

The second objective of the present invention is to provide an improved LED backlight module, in which a plurality of extended thermal-conductivity layers are connected to a plurality of the soldering points of a copper circuit layer, and a majority of the extended thermal-conductivity layers are further attached to the surface of the bottom plate of the main frame through an insulating and thermal-conductivity adhesive; So that, when the LED chips emit the light, the soldering points would conduct the heat produced by the LED chips to the extended thermal-conductivity layers, so as to evenly distribute the heat over the surface of the bottom plate through the extended thermal-conductivity layer; moreover, a supporting member is used for supporting the extended thermal-conductivity layers, so as to avoid the extended thermal-conductivity layers from being broken as the extended thermal-conductivity layers are assembled.

So that, to achieve the second objective of the present invention, the inventor proposes an improved LED backlight module, which is disposed on a main frame with a bottom plate and an edge, and comprises:

a supporting body, disposed on the edge of the main frame;

a supporting member, disposed on the bottom plate of the main frame and connected to the supporting body, and having an inner surface and an outer surface;

a copper circuit layer, attached to the inner surface of the supporting member via a first insulating and thermal-conductivity adhesive, and extended to the outer surface of the supporting member, wherein the copper circuit layer comprises a plurality of main circuits, a plurality of soldering points and an electrically connecting portion;

a plurality of LED chips, disposed on the copper circuit layer and welded to the plurality of soldering points;

a plurality of extended thermal-conductivity layers, connected with the soldering points, wherein the extended thermal-conductivity layers are attached to the inner surface of the supporting member through the first insulating and thermal-conductivity adhesive;

a light guide plate, opposite to the LED chips by a light-incident surface thereof for receiving light emitted by the LED chips; and

a bottom reflecting member, attached to the bottom surface of the light guide plate and used for preventing from the light leakage;

wherein when the LED chips emit the light, the soldering points conduct the heat produced by the LED chips to the extended thermal-conductivity layers, so as to evenly distribute the heat over the surface of the bottom plate via the supporting member.

The third objective of the present invention is to provide an improved LED backlight module, in which a plurality of extended thermal-conductivity layers are connected to a plurality of the soldering points of a copper circuit layer, and a majority of the extended thermal-conductivity layers are further attached to the surface of the bottom plate of the main frame through an insulating and thermal-conductivity adhesive; So that, when the LED chips emit the light, the soldering points would conduct the heat produced by the LED chips to the extended thermal-conductivity layers, so as to evenly distribute the heat over the surface of the bottom plate through the extended thermal-conductivity layer; moreover, the main circuits of the copper circuit layer can be extendedly attached on the outer surface of the supporting body by way of passing through the passing holes, such that the applicability of the copper circuit layer is increased.

Therefore, to achieve the third objective of the present invention, the inventor proposes an improved LED backlight module, which is disposed on a main frame with a bottom plate, and comprises:

a supporting body, having an inner surface, an outer surface and a plurality of passing holes passing through from the inner surface to the outer surface;

a copper circuit layer, attached to the inner surface of the supporting body via an insulating and thermal-conductivity adhesive, wherein the copper circuit layer comprises a plurality of main circuits, a plurality of soldering points and an electrically connecting portion, moreover, the main circuits are extendedly attached on the outer surface of the supporting body by way of passing through the passing holes;

a plurality of LED chips, disposed on the copper circuit layer and welded to the plurality of soldering points;

a plurality of extended thermal-conductivity layers, connected with the soldering points, wherein a minority of the extended thermal-conductivity layers are attached to the inner surface of the supporting body through the insulating and thermal-conductivity adhesive, and a majority of the extended thermal-conductivity layers are horizontally extended from the inner surface of the supporting body for being attached to the surface of the bottom plate of the main frame through the insulating and thermal-conductivity adhesive;

a light guide plate, opposite to the LED chips by a light-incident surface thereof for receiving light emitted by the LED chips; and

a bottom reflecting member, attached to the bottom surface of the light guide plate and used for preventing from the light leakage;

wherein when the LED chips emit the light, the soldering points conducting the heat produced by the LED chips to the extended thermal-conductivity layers, so as to evenly distribute the heat over the surface of the bottom plate through the extended thermal-conductivity layers.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a side view of a conventional LED backlight module;

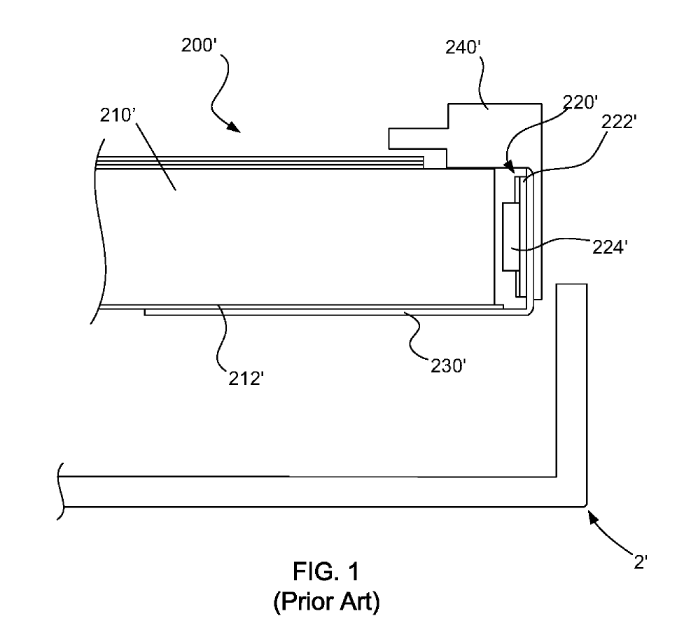

FIG. 2 is a side view of a first embodiment of an improved LED backlight module according to the present invention;

FIG. 3 is an exploded view of the first embodiment of the improved LED backlight module according to the present invention;

FIG. 4 is a second side view of the first embodiment of the improved LED backlight module according to the present invention;

FIG. 5 is a third side view of the first embodiment of the improved LED backlight module according to the present invention;

FIG. 6 is a side view of a second embodiment of the improved LED backlight module according to the present invention;

FIG. 7 is a side view of a third embodiment of the improved LED backlight module according to the present invention;

FIG. 8 is an exploded view of the third embodiment of the improved LED backlight module according to the present invention;

FIG. 9 is a second side view of the third embodiment of the improved LED backlight module according to the present invention;

FIG. 10 is a side view of a fourth embodiment of the improved LED backlight module according to the present invention;

FIG. 11 is a side view of a fifth embodiment of the improved LED backlight module according to the present invention;

FIG. 12 is an exploded view of the fifth embodiment of the improved LED backlight module according to the present invention;

FIG. 13 is a second side view of the fifth embodiment of the improved LED backlight module according to the present invention;

FIG. 14 is a side view of a sixth embodiment of the improved LED backlight module according to the present invention;

FIG. 15 is a side view of a seventh embodiment of the improved LED backlight module according to the present invention;

FIG. 16 is a top view of a supporting body, a copper circuit layer and a plurality of extended thermal-conductivity layers of the improved LED backlight module;

FIG. 17 is a second side view of the seventh embodiment of the improved LED backlight module according to the present invention;

FIG. 18 is a side view of an eighth embodiment of the improved LED backlight module according to the present invention;

FIG. 19 is an exploded view of the eighth embodiment of the improved LED backlight module according to the present invention; and

FIG. 20 is a second side view of the eighth embodiment of the improved LED backlight module according to the present invention.

### DETAILED DESCRIPTION OF THE INVENTION

To more clearly describe an improved LED backlight module according to the present invention, embodiments of the present invention will be described in detail with reference to the attached drawings hereinafter.

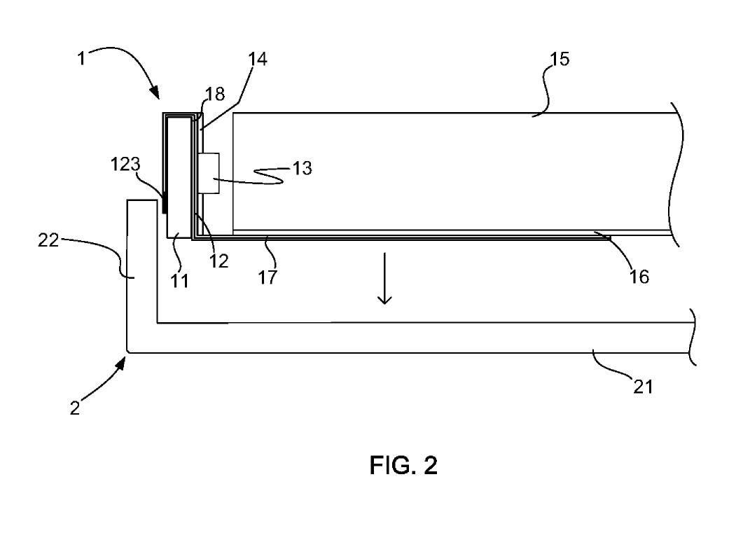

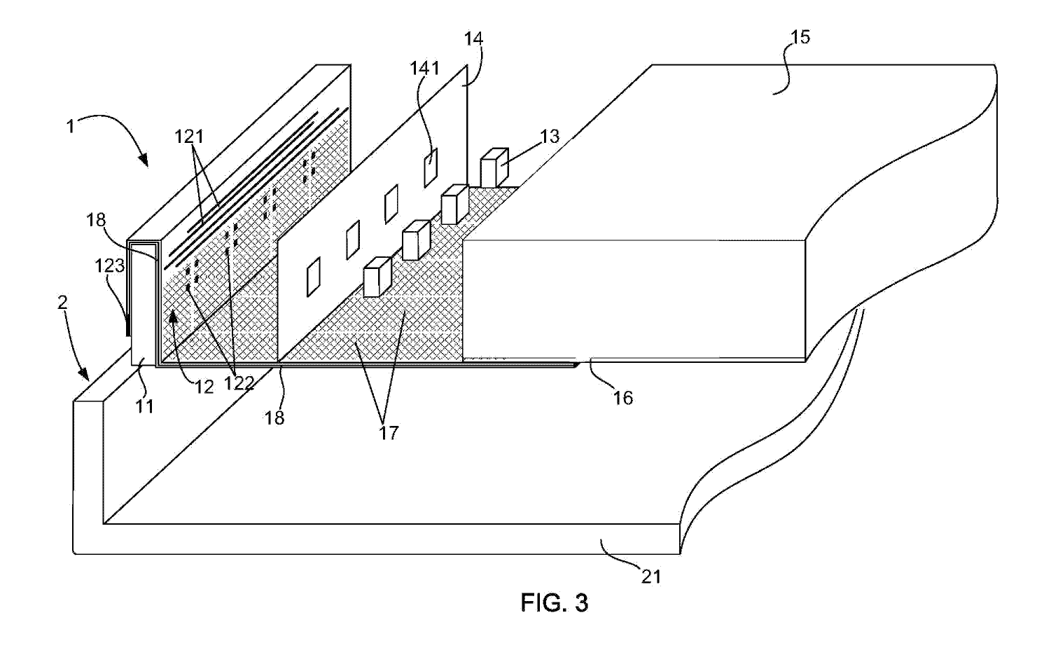

In the present invention, it proposes various embodiments for the improved LED backlight module. Please refer to FIG. 2 and FIG. 3, there are shown a side view and an exploded view of a first embodiment of the improved LED backlight module according to the present invention. As shown in FIG. 2 and FIG. 3, the improved LED backlight module 1 is installed in a liquid crystal display device (not shown) and disposed on a main frame 2 with a bottom plate 21 and at lease one edge 22. The improved LED backlight module 1 includes: a supporting body 11, a copper circuit layer 12, a plurality of LED chips 13, a reflecting member 14, a plurality of extended thermal-conductivity layers 17, a light guide plate 15, and a bottom reflecting member 16.

The supporting body 11 can be fabricated to a “ [symbol] ” shaped supporting body, a “L” shaped supporting body or a “l” shaped supporting body by using a metal or a fiberglass as the manufacturing material, and the supporting body 11 has an inner surface and an outer surface. The copper circuit layer 12 is attached to the inner surface of the supporting body 11 via an insulating and thermal-conductivity adhesive 18, and further extended to the outer surface of the supporting body 11, wherein the copper circuit layer 12 consists of a plurality of main circuits 121, a plurality of soldering points 122 and an electrically connecting portion 123. The LED chips 13 are disposed on the copper circuit layer 12 and welded to the plurality of soldering points 122, wherein and the electrically connecting portion 123 of the copper circuit layer 12 is used for electrically connecting to a circuit controlling unit (not shown) installed in the liquid crystal display device, such that the circuit controlling unit can control the LED chips 13 to emit light.

The extended thermal-conductivity layers 17 are connected with the soldering points 122, in which, a minority of the extended thermal-conductivity layers 17 are attached to the inner surface of the supporting body 11 and a majority of the extended thermal-conductivity layers 17 are horizontally extended from the inner surface of the supporting body 11 for being attached to the surface of the bottom plate 21 of the main frame 2 through the insulating and thermal-conductivity adhesive 18. The reflecting layer 14 is opposite to the LED chips 13 and disposed on the copper circuit layer 12, and the reflecting layer 14 has a plurality of through holes 141 for being passed by the plurality of LED chips 13, respectively. Similar to the supporting body 11, the reflecting layer 14 can also be fabricated to a “ [symbol] ” shaped reflecting layer, a “L”shaped reflecting layer or a “l”shaped reflecting layer. In addition, the light guide plate 15 is also opposite to the LED chips 13 by a light-incident surface thereof for receiving light emitted by the LED chips 13, and the bottom reflecting member 16 is attached to the bottom surface of the light guide plate 15 and used for preventing from the light leakage.

Moreover, it needs to especially note that, in order to facilitate it to dispose the main circuits 121 on the surface of the supporting body 11, the partial main circuits 121 of the copper circuit layer 12 can be made to lacquered wires and attached to the surface of the supporting body 11, and then others main circuits 121 can be jointed with the lacquered wires by way of the pressure electroslag remelting when the others main circuits 121 are attached to the surface of the supporting body 11.

Therefore, the above descriptions have been clearly and completely introduced the first embodiment of the improved LED backlight module of the present invention; in summary, the improved LED backlight module has the following advantages:
1. In the present invention, it mainly connects the plurality of extended thermal-conductivity layers 17 to the plurality of the soldering points 122 of the copper circuit layer 12, and attaches a majority of the extended thermal-conductivity layers 17 to the surface of the bottom plate 21 of the main frame 2 through the insulating and thermal-conductivity adhesive 18; So that, when the LED chips 13 emit light, the soldering points 122 conduct the heat produced by the LED chips 13 to the extended thermal-conductivity layers 17, so as to evenly distribute the heat over the surface of the bottom plate 21 through the extended thermal-conductivity layers 17.
2. Moreover, the copper circuit layer 12 is disposed on the inner surface of the supporting body 11 and can be further extendedly attached to the outer surface of the supporting body 11 for effectively increasing the circuit layout area.

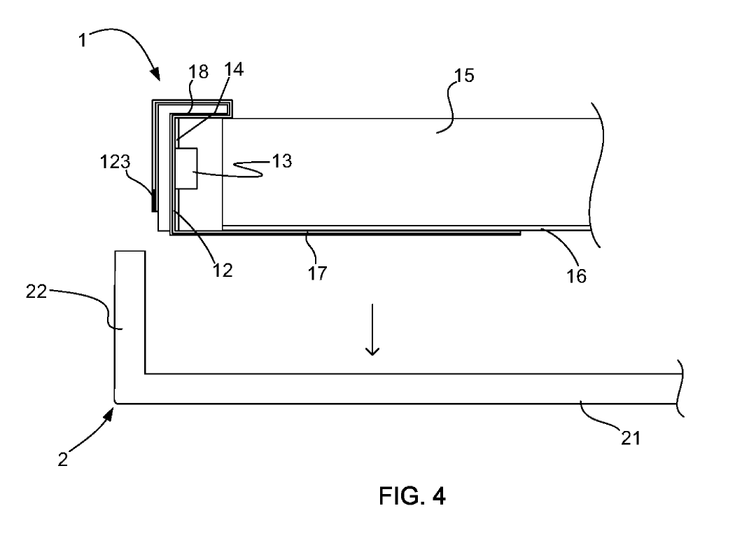

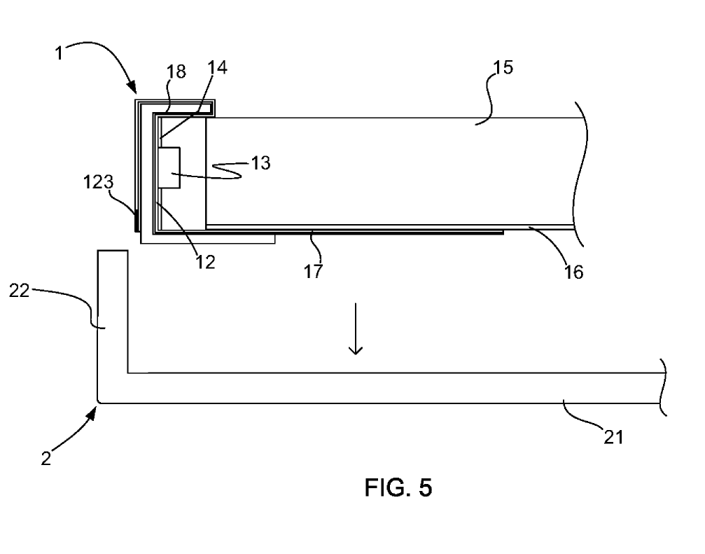

Besides, please refer to FIG. 4 and FIG. 5, there are shown a second side view and a third side view of the first embodiment of the improved LED backlight module according to the present invention. In which, FIG. 4 illustrates an improved LED backlight module 1 with the “L” shaped supporting body 11, and FIG. 5 illustrates an improved LED backlight module 1 with the “ [symbol] ” shaped supporting body 11; moreover, the reflecting layer 14 is accordingly fabricated to the “L” shaped reflecting layer 14 and “ [symbol] ” shaped reflecting layer 14 in FIG. 4 and FIG. 5, respectively.

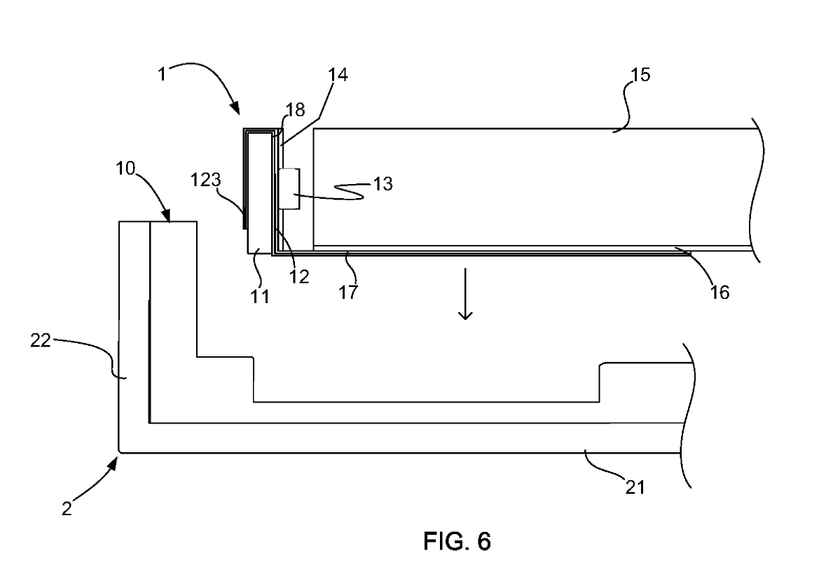

In the present invention, it also proposes a second embodiment for the improved LED backlight module. Please refer to FIG. 6, which illustrates a side view of the second embodiment of the improved LED backlight module according to the present invention. As shown in FIG. 6, the second embodiment of the improved LED backlight module 1 includes: a supporting body 11, a copper circuit layer 12, a plurality of LED chips 13, a reflecting member 14, a plurality of extended thermal-conductivity layers 17, a light guide plate 15, a bottom reflecting member 16, and an extruded body 10, wherein the supporting body 11, the copper circuit layer 12, the LED chips 13, the reflecting member 14, the extended thermal-conductivity layers 17, the light guide plate 15, and the bottom reflecting member 16 introduced in the second embodiment are the same to the supporting body 11, the copper circuit layer 12, the LED chips 13, the reflecting member 14, the extended thermal-conductivity layers 17, the light guide plate 15, and the bottom reflecting member 16 introduced in aforesaid first embodiment of the improved LED backlight module 1.

Different from the first embodiment, in the second embodiment of the improved LED backlight module 1, it further has the extruded body 10, which is disposed on the main frame 2 and used for accommodating the supporting body 11, the copper circuit layer 12 and the LED chips 13. The extruded body 10 can effectively protect the supporting body 11, the copper circuit layer 12 and the LED chips 13 from being broken as the improved LED backlight module 1 suffers an impact of an external force.

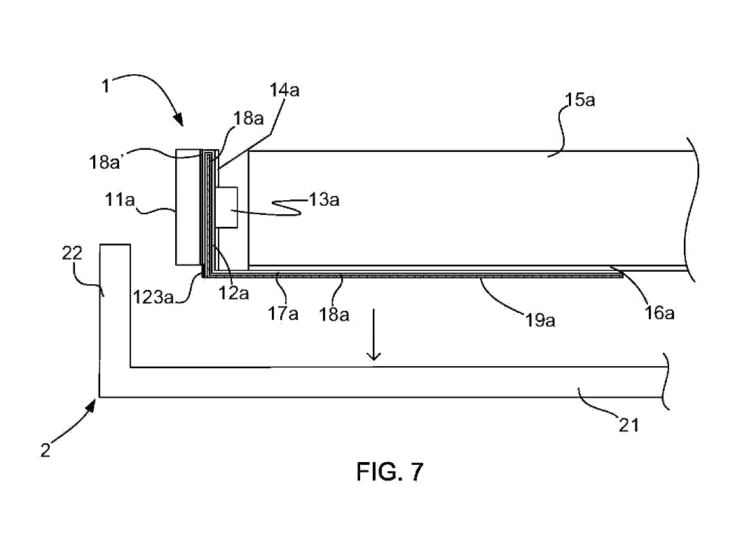

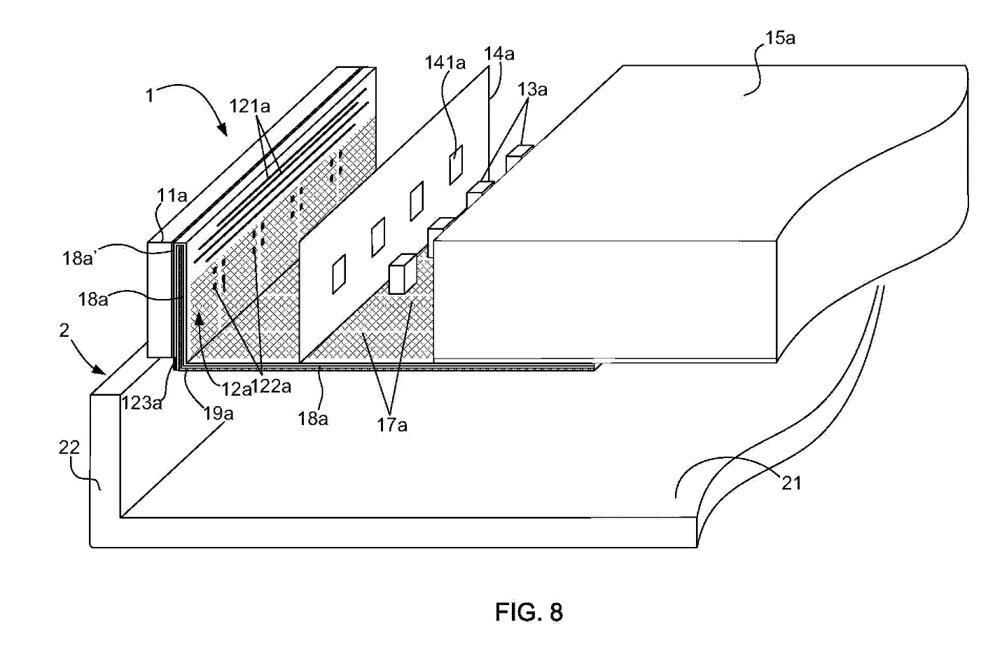

Moreover, the present invention further proposes a third embodiment for the improved LED backlight module. Please refer to FIG. 7 and FIG. 8, there are shown a side view and an exploded view of the third embodiment of the improved LED backlight module according to the present invention. As shown in FIG. 7 and FIG. 8, the improved LED backlight module 1 is installed in a liquid crystal display device (not shown) and disposed on a main frame 2 with a bottom plate 21 and at lease one edge 22. The improved LED backlight module 1 includes: a supporting body 11a, a supporting member 19a, a copper circuit layer 12a, a plurality of LED chips 13a, a reflecting member 14a, a plurality of extended thermal-conductivity layers 17a, a light guide plate 15a, and a bottom reflecting member 16a, and the supporting body 11a is a “l”shaped supporting body and disposed on the edge 22 of the main frame 2.

The supporting member 19a is disposed on the bottom plate 21 of the main frame 2 and connected to the supporting body 11a, and supporting member 19a has an inner surface and an outer surface. The copper circuit layer 12a is attached to the inner surface of the supporting member 19a via a first insulating and thermal-conductivity adhesive 18a, and is extended to the outer surface of the supporting member 19a, wherein the copper circuit layer 12a consists of a plurality of main circuits 121a, a plurality of soldering points 122a and an electrically connecting portion 123a. The LED chips 13a are disposed on the copper circuit layer 12a and welded to the plurality of soldering points 122a, wherein and the electrically connecting portion 123a of the copper circuit layer 12a is used for electrically connecting to a circuit controlling unit (not shown) installed in the liquid crystal display device, such that the circuit controlling unit can control the LED chips 13a to emit light.

The extended thermal-conductivity layers 17a are connected with the soldering points 122a, wherein the extended thermal-conductivity layers 17a are attached to the inner surface of the supporting member 19a through the first insulating and thermal-conductivity adhesive 18a. The reflecting layer 14a is opposite to the LED chips 13a and disposed on the copper circuit layer 12a, wherein the reflecting layer 14a is a “l”reflecting layer and has a plurality of through holes 141a for being passed by the plurality of LED chips 13a, respectively. In addition, the light guide plate 15a is opposite to the LED chips 13a by a light-incident surface thereof for receiving light emitted by the LED chips 13a, and the bottom reflecting member 16a is attached to the bottom surface of the light guide plate 15a and used for preventing from the light leakage.

For the third embodiment of the improved LED backlight module 1, the manufacturing material of the supporting body 11a can be metal or fiberglass; similarly, manufacturing material of the supporting member 19a can also be metal or fiberglass. As shown in FIG. 7, when both the materials of the supporting body 11a and the supporting member 19a are metal, the supporting member 19a is connected with the supporting body 11a through a second insulating and thermal-conductivity adhesive 18a′. Moreover, when both the materials of the supporting body 11a and the supporting member 19a are fiberglass, the supporting member 19a can be connected to the supporting body 11a via a thermal-conductivity adhesive.

So that, the above descriptions have been clearly and completely introduced the third embodiment of the improved LED backlight module of the present invention; in summary, the improved LED backlight module has the following advantages:
A. The same to the aforesaid first embodiment, in the third embodiment of the improved LED backlight module, it also connects the plurality of extended thermal-conductivity layers 17a to the plurality of the soldering points 122a of the copper circuit layer 12a, and attaches a majority of the extended thermal-conductivity layers 17a to the surface of the bottom plate 21 of the main frame 2 through the first insulating and thermal-conductivity adhesive 18a; So that, when the LED chips 13a emit light, the soldering points 122a conduct the heat produced by the LED chips 13a to the extended thermal-conductivity layers 17a, so as to evenly distribute the heat over the surface of the bottom plate 21 via the supporting member 19a.
B. Inheriting to above point A, the supporting member 19a is able to support the extended thermal-conductivity layers 17a, so as to avoid the extended thermal-conductivity layers 17a from being broken as the extended thermal-conductivity layers are assembled.
C. Moreover, the copper circuit layer 12a is not only attached to the inner surface of the supporting member 19a but also can be further extendedly attached to the outer surface of the supporting member 19a, such that the circuit layout area is effectively increased.

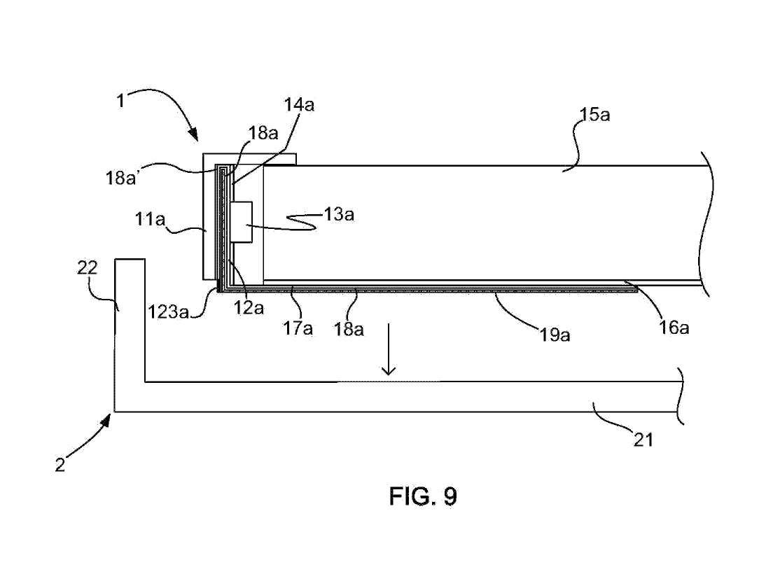

Besides, please refer to FIG. 9, there is shown a second side view of the third embodiment of the improved LED backlight module according to the present invention. For the supporting body 11a in the improved LED backlight module 1 can be a “ [symbol] ” shaped supporting body, a “L” shaped supporting body or a “l” shaped supporting body, as shown in FIG. 9, an improved LED backlight module 1 with the “L” shaped supporting body 11a is illustrated; Moreover, the reflecting layer 14a is accordingly fabricated to the “L” shaped reflecting layer 14 in FIG. 9.

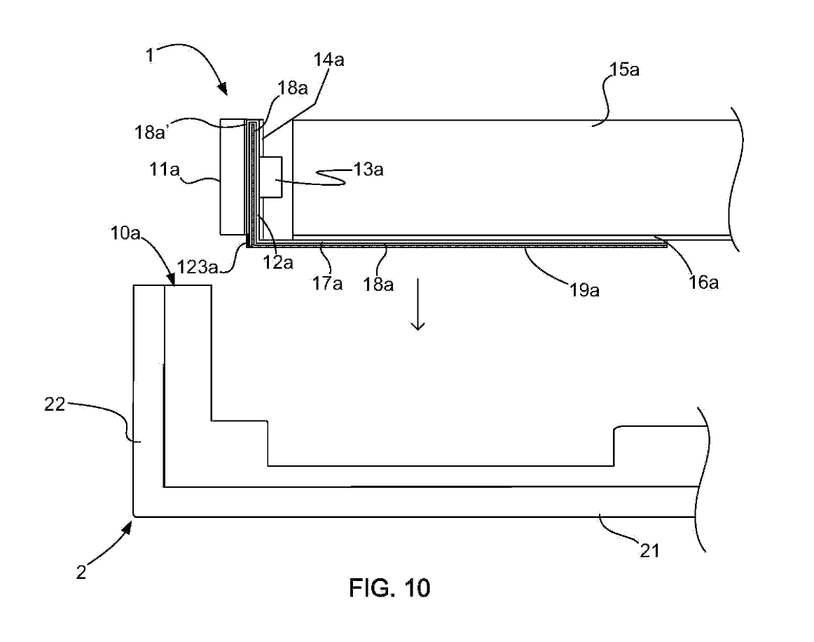

The present invention further proposes a fourth embodiment for the improved LED backlight module. Please refer to FIG. 10, which illustrates a side view of the fourth embodiment of the improved LED backlight module according to the present invention. As shown in FIG. 10, the fourth embodiment of the improved LED backlight module 1 includes: a supporting body 11a, a supporting member 19a, a copper circuit layer 12a, a plurality of LED chips 13a, a reflecting member 14a, a plurality of extended thermal-conductivity layers 17a, a light guide plate 15a, a bottom reflecting member 16a, and an extruded body 10a, wherein the supporting body 11a, the supporting member 19a, the copper circuit layer 12a, the LED chips 13a, the reflecting member 14a, the extended thermal-conductivity layers 17a, the light guide plate 15a, and the bottom reflecting member 16a introduced in the fourth embodiment are the same to the supporting body 11a, the supporting member 19a, the copper circuit layer 12a, the LED chips 13a, the reflecting member 14a, the extended thermal-conductivity layers 17a, the light guide plate 15a, and the bottom reflecting member 16a introduced in aforesaid third embodiment of the improved LED backlight module 1.

Different from the third embodiment, in the fourth embodiment of the improved LED backlight module 1, it further has the extruded body 10a, which is disposed on the main frame 2 and used for accommodating the supporting body 11a, the supporting member 19a, the copper circuit layer 12a, and the LED chips 13a. The extruded body 10a can effectively protect the supporting body 11a, the supporting member 19a, the copper circuit layer 12a, and the LED chips 13a from being broken as the improved LED backlight module 1 suffers an impact of an external force.

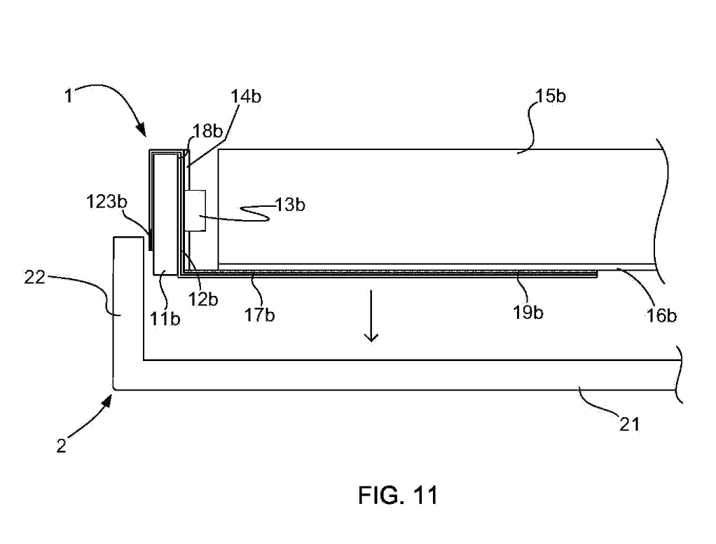

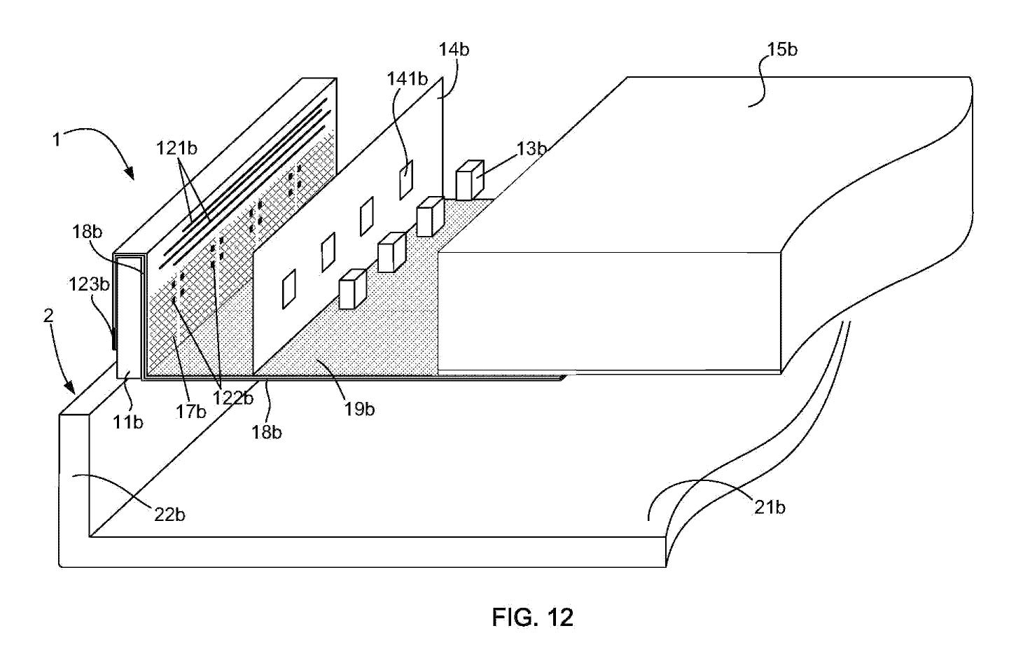

Moreover, the present invention further proposes a fifth embodiment for the improved LED backlight module. Please refer to FIG. 11 and FIG. 12, there are shown a side view and an exploded view of the fifth embodiment of the improved LED backlight module according to the present invention. As shown in FIG. 11 and FIG. 12, the improved LED backlight module 1 is installed in a liquid crystal display device (not shown) and disposed on a main frame 2 with a bottom plate 21 and at lease one edge 22. The improved LED backlight module 1 includes: a supporting body 11b, a copper circuit layer 12b, a plurality of LED chips 13b, a reflecting member 14b, a plurality of extended thermal-conductivity layers 17b, a light guide plate 15b, and a bottom reflecting member 16b, and the supporting body 11b is fabricated to a “l” shaped supporting body by using metal or fiberglass as manufacturing material, and the supporting body 11b has an inner surface and an outer surface and is disposed on the edge 22 of the main frame 2.

The copper circuit layer 12b is attached to the inner surface of the supporting body 11b via an insulating and thermal-conductivity adhesive 18b, and is extended to the outer surface of the supporting body 11b, wherein the copper circuit layer 12b consists of a plurality of main circuits 121b, a plurality of soldering points 122b and an electrically connecting portion 123b. The LED chips 13b are disposed on the copper circuit layer 12b and welded to the plurality of soldering points 122b, wherein and the electrically connecting portion 123b of the copper circuit layer 12b is used for electrically connecting to a circuit controlling unit (not shown) installed in the liquid crystal display device, such that the circuit controlling unit can control the LED chips 13b to emit light. In addition, the reflecting layer 14b is opposite to the LED chips 13b and disposed on the copper circuit layer 12b, wherein the reflecting layer 14b is a “l” shaped reflecting layer and has a plurality of through holes 141b for being passed by the plurality of LED chips 13b, respectively.

The extended thermal-conductivity layers 17b are connected with the soldering points 122b, wherein a minority of the extended thermal-conductivity layers 17b are attached to the inner surface of the supporting body 11b through the insulating and thermal-conductivity adhesive 18b, and a majority of the extended thermal-conductivity layers 17b are horizontally extended from the inner surface of the supporting body 11b for being attached to the surface of the bottom plate 21 of the main frame 2 through the insulating and thermal-conductivity adhesive 18b. Moreover, the supporting member 19b is connected to the extended thermal-conductivity layers 17b by way of being disposed on the extended thermal-conductivity layers 17b, and the material of the supporting member 19b is plastic. The supporting member 19b is used for supporting the extended thermal-conductivity layers 17b, and protecting the extended thermal-conductivity layers 17b from being broken as the extended thermal-conductivity layers 17b are assembled. In addition, the light guide plate 15b is opposite to the LED chips 13b by a light-incident surface thereof for receiving light emitted by the LED chips 13b, and the bottom reflecting member 16b is attached to the bottom surface of the light guide plate 15b and used for preventing from the light leakage.

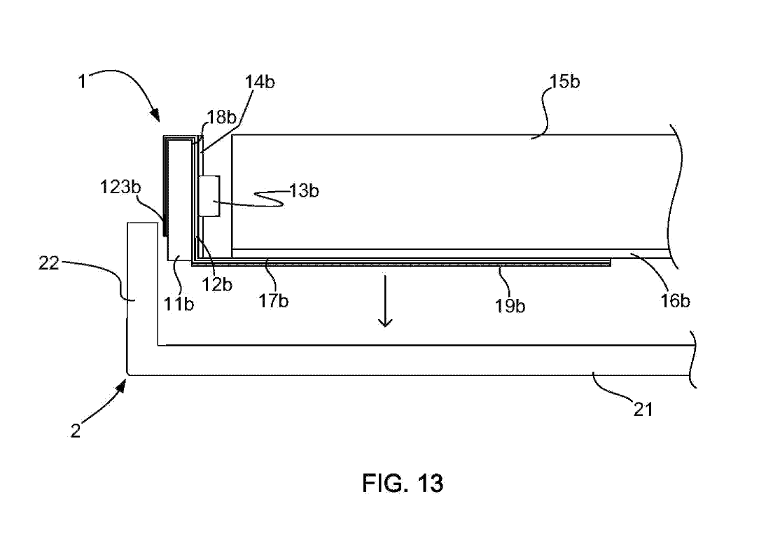

Therefore, through the framework and structure of the fifth embodiment of the improved LED backlight module 1, the soldering points 122b may conduct the heat produced by the LED chips 13b to the extended thermal-conductivity layers 17b when the LED chips 13b emit light, and then the heat can be evenly distributed over the surface of the bottom plate 21 through the extended thermal-conductivity layers 17b. Furthermore, please refer to FIG. 13, which illustrates a second side view of the fifth embodiment of the improved LED backlight module according to the present invention. As shown in FIG. 13, the supporting member 19a can also be connected to the extended thermal-conductivity layers 17b by way of being disposed under the extended thermal-conductivity layers 17b, and the manufacturing material of the supporting member 19a is metal.

Besides, it needs to note that, the length of the supporting member 19b can not be the same to the length of the extended thermal-conductivity layers 17b if the supporting member 19b is disposed under the insulating and thermal-conductivity adhesive 18b; i.e., the length of the supporting member 19b can be greater than the length of the extended thermal-conductivity layers 17b, such that the supporting member 19b and the extended thermal-conductivity layers 17b can be simultaneously attached to the bottom plate 21 of the main frame 2. Moreover, it also needs to note that, the manufacturing material of the supporting member 19a is not limited to metal or plastic.

The same to above described embodiments, in the fifth embodiment of the improved LED backlight module, the supporting body can be a “ [symbol] ” shaped supporting body, a “L” shaped supporting body or a “l” shaped supporting body and the reflecting layer 14b can accordingly fabricated as a “ [symbol] ” shaped reflecting layer, a “L” shaped reflecting layer or a “l” shaped reflecting layer. Besides, in order to facilitate it to dispose the main circuits 121b on the surface of the supporting body 11b, the partial main circuits 121b of the copper circuit layer 12b can be made to lacquered wires and attached to the surface of the supporting body 11b, and then others main circuits 121b can be jointed with the lacquered wires by way of the pressure electroslag remelting when the others main circuits 121b are attached to the surface of the supporting body 11b.

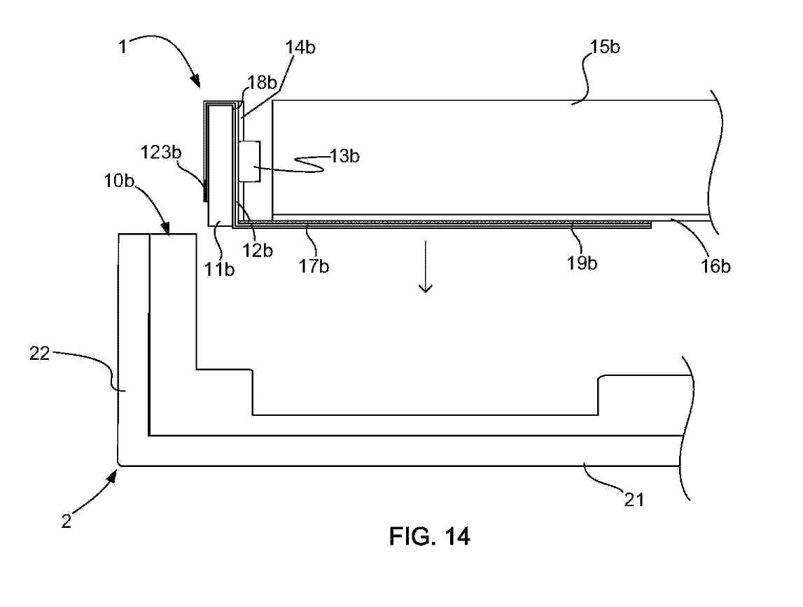

The present invention further proposes a sixth embodiment for the improved LED backlight module. Please refer to FIG. 14, which illustrates a side view of the sixth embodiment of the improved LED backlight module according to the present invention. As shown in FIG. 14, the sixth embodiment of the improved LED backlight module 1 includes: a supporting body 11b, a copper circuit layer 12b, a plurality of LED chips 13b, a reflecting member 14b, a plurality of extended thermal-conductivity layers 17b, a supporting member 19b, a light guide plate 15b, a bottom reflecting member 16b, and an extruded body 10b, wherein the supporting body 11b, the copper circuit layer 12b, the LED chips 13b, the reflecting member 14b, the extended thermal-conductivity layers 17b, the supporting member 19b, the light guide plate 15b, and the bottom reflecting member 16b introduced in the sixth embodiment are the same to the supporting body 11b, the supporting member 19b, the copper circuit layer 12b, the LED chips 13b, the reflecting member 14b, the extended thermal-conductivity layers 17b, the supporting member 19b, the light guide plate 15b, and the bottom reflecting member 16b introduced in aforesaid fifth embodiment of the improved LED backlight module 1.

Different from the fifth embodiment, in the sixth embodiment of the improved LED backlight module 1, it further has the extruded body 10b, which is disposed on the main frame 2 and used for accommodating the supporting body 11b, the supporting member 19b, the copper circuit layer 12b, and the LED chips 13b. The extruded body 10b can effectively protect the supporting body 11b, the supporting member 19b, the copper circuit layer 12b, and the LED chips 13b from being broken as the improved LED backlight module 1 suffers an impact of an external force.

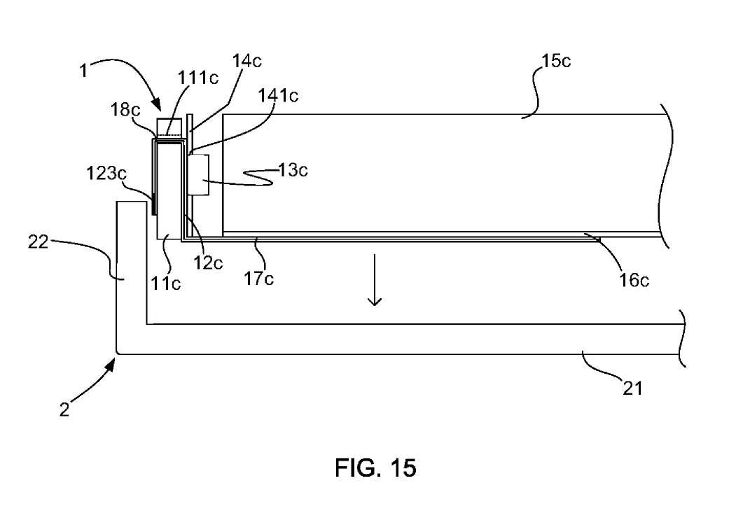

The present invention further proposes a seventh embodiment for the improved LED backlight module. Please refer to FIG. 15, which illustrates a side view of the seventh embodiment of the improved LED backlight module according to the present invention. As shown in FIG. 15, the improved LED backlight module 1 includes: a supporting body 11c, a copper circuit layer 12c, a plurality of LED chips 13c, a reflecting member 14c, a plurality of extended thermal-conductivity layers 17c, a light guide plate 15c, and a bottom reflecting member 16c.

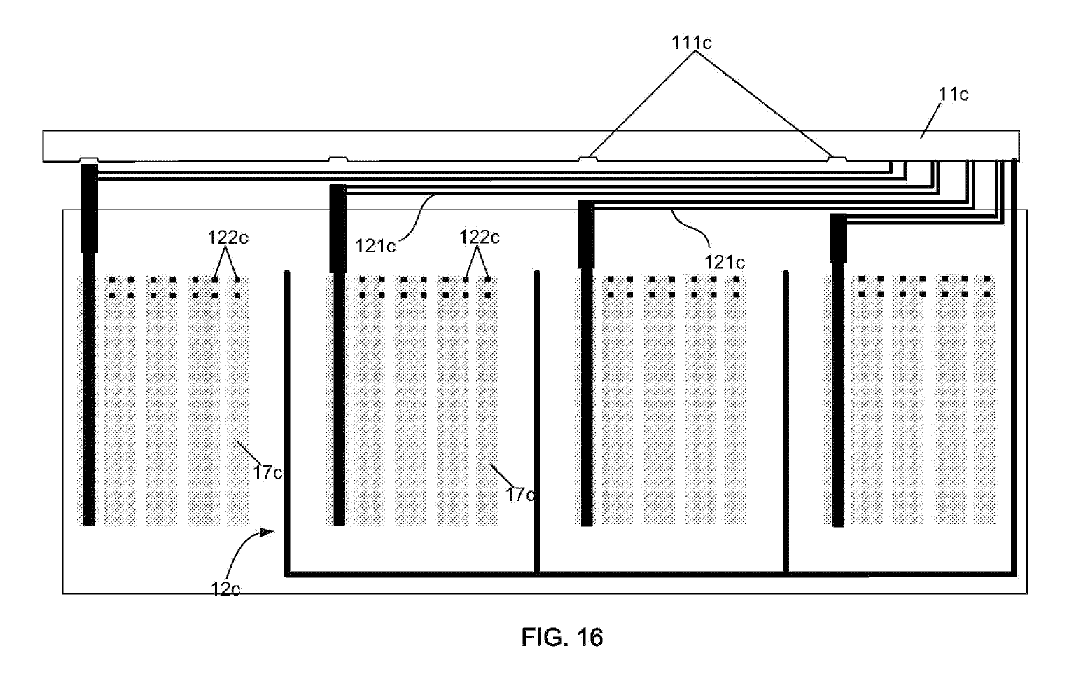

Please simultaneously refer to FIG. 16, there is shown a top view of the supporting body, the copper circuit layer and the extended thermal-conductivity layers of the improved LED backlight module. As shown in FIG. 15 and FIG. 16, the supporting body 11c can be made by using metal or fiberglass as the manufacturing material, wherein the supporting body 11c has an inner surface, an outer surface and a plurality of passing holes 111c passing through from the inner surface to the outer surface. The copper circuit layer 12c is attached to the inner surface of the supporting body 11c via an insulating and thermal-conductivity adhesive 18c. The copper circuit layer 12c consists of a plurality of main circuits 121c, a plurality of soldering points 122c and an electrically connecting portion 123c, and the main circuits 121c are extendedly attached on the outer surface of the supporting body 11c by way of passing through the passing holes 111c. The electrically connecting portion 123c of the copper circuit layer 12c is used for electrically connecting to a circuit controlling unit installed in the liquid crystal display device.

The LED chips 13c are disposed on the copper circuit layer 12c and welded to the plurality of soldering points 122c. The reflecting layer 14c is a “l” shaped reflecting layer and has a plurality of through holes 141c for being passed by the plurality of LED chips 13c, respectively. In addition, the light guide plate 15c is opposite to the LED chips 13c by a light-incident surface thereof for receiving light emitted by the LED chips 13c, and the bottom reflecting member 16c, being attached to the bottom surface of the light guide plate 15c and used for preventing from the light leakage.

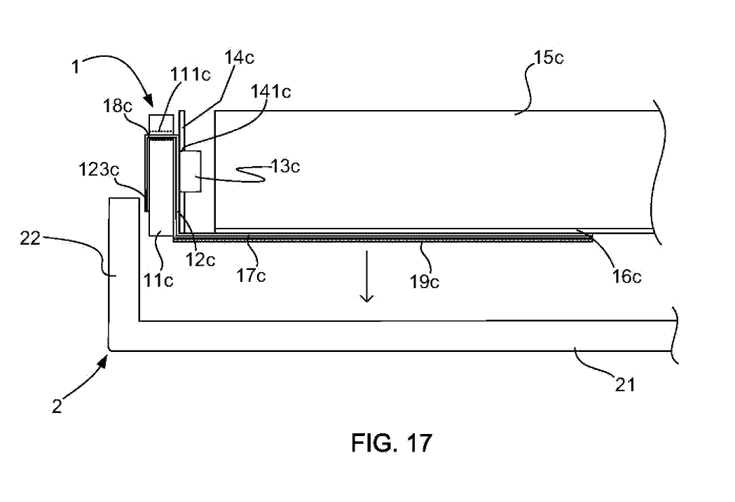

The same to above described embodiments, in the seventh embodiment of the improved LED backlight module, the supporting body 11c can be a “ [symbol] ” shaped supporting body, a “L” shaped supporting body or a “l” shaped supporting body and the reflecting layer 14c can accordingly fabricated as a “ [symbol] ”shaped reflecting layer, a “L” shaped reflecting layer or a “l” shaped reflecting layer. Moreover, please refer to FIG. 17, there is shown second side view of the seventh embodiment of the improved LED backlight module according to the present invention. As shown in FIG. 17, a supporting member 19c can be added into the seventh embodiment of the improved LED backlight module 1, where in the supporting member 19c is disposed under the insulating and thermal-conductivity adhesive 18c, and the material of the supporting member 19c is plastic. Besides, the supporting member 19c can also be connected to the extended thermal-conductivity layers 17c by way of being disposed on the extended thermal-conductivity layers 17c, therefore, the supporting member 19c is able to support the extended thermal-conductivity layers 17c, and the protect extended thermal-conductivity layers 17c from being broken as the extended thermal-conductivity layers 17c are assembled.

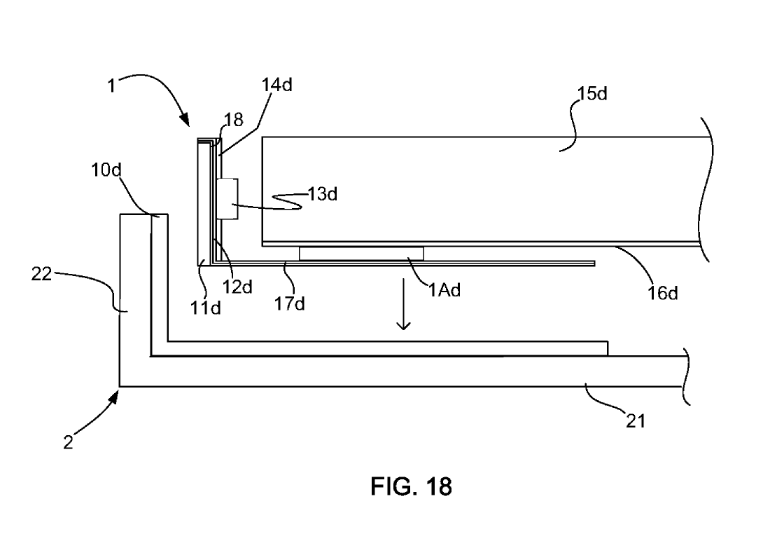

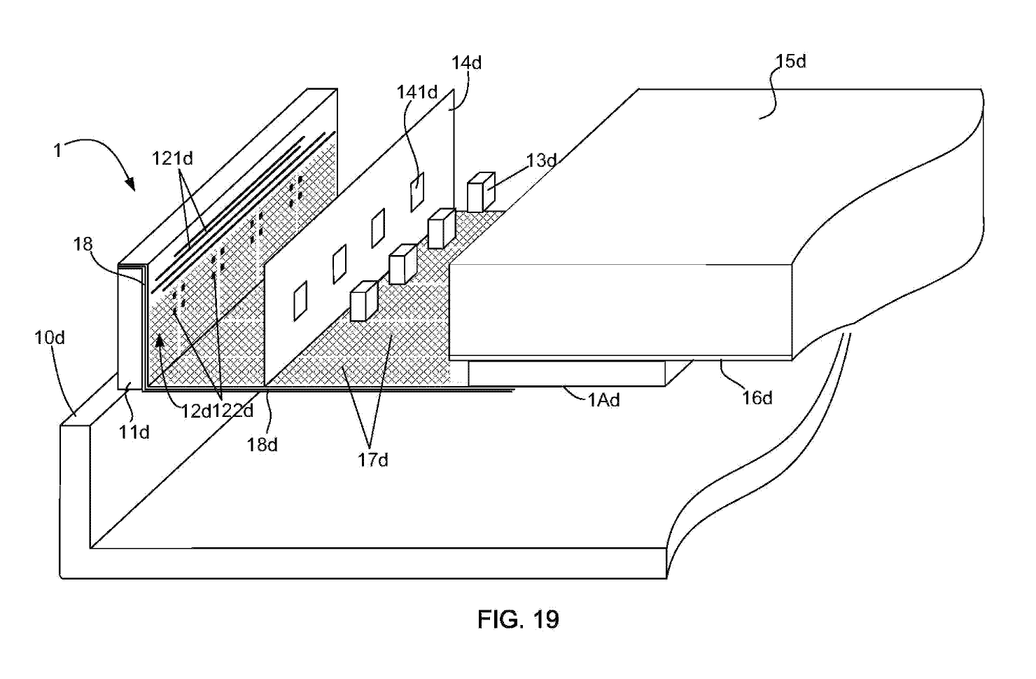

Finally, the present invention further proposes an eighth embodiment for the improved LED backlight module. Please refer to FIG. 18 and FIG. 19, there are shown a side view and an exploded view of the eighth embodiment of the improved LED backlight module according to the present invention. As shown in FIG. 18 and FIG. 19, the eighth embodiment of the improved LED backlight module 1 includes: sheet metal member 10d, a supporting body 11d, a copper circuit layer 12d, a plurality of LED chips 13d, a reflecting member 14d, a plurality of extended thermal-conductivity layers 17d, a light guide plate 15d, a bottom reflecting member 16d, and a buffer layer 1Ad, wherein the sheet metal member 10d is disposed on the main frame 2. The supporting body 11d can be fabricated to a “ [symbol] ” shaped supporting body, a “L” shaped supporting body or a “l” shaped supporting body by using a metal or a fiberglass as the manufacturing material. The “l” shaped supporting body 11d illustrated in FIG. 18 and FIG. 19 is disposed on the sheet metal member 10d and has an inner surface and an outer surface.

The copper circuit layer 12d is attached to the inner surface of the supporting body 11d and extendedly attached to the outer surface of the supporting body 11d through an insulating and thermal-conductivity adhesive 18d, wherein the copper circuit layer 12d consists of a plurality of main circuits 121d and a plurality of soldering points 122d. Moreover, the partial main circuits 121d of the copper circuit layer 12d can be made to lacquered wires and attached to the surface of the supporting body 11d, and then others main circuits 121d can be jointed with the lacquered wires by way of the pressure electroslag remelting when the others main circuits 121d are attached to the surface of the supporting body 11d.

The LED chips 13d are disposed on the copper circuit layer 12d and welded to the plurality of soldering points 122d. The reflecting layer 14c can be a “ [symbol] ” shaped reflecting layer, a “L”shaped reflecting layer or a “l” shaped reflecting layer, and the “l” shaped reflecting layer 14d illustrated in FIG. 18 and FIG. 19 is opposite to the LED chips and disposed on the copper circuit layer 12d, and the reflecting layer 14c has a plurality of through holes 141d for being passed by the plurality of LED chips 13d, respectively. In addition, the light guide plate 15d is opposite to the LED chips 13d by a light-incident surface thereof for receiving light emitted by the LED chips 13d, and the bottom reflecting member 16d, being attached to the bottom surface of the light guide plate 15d and used for preventing from the light leakage.

Different from the aforesaid embodiments of the improved LED backlight module, the eighth embodiment of the improved LED backlight module includes one buffer layer 1Ad, which is disposed under the bottom of the bottom reflecting member 16d and used for blocking up the bottom reflecting member 16d and the light guide plate 15d, such that the light guide plate 15d may receiving light more efficiently. In addition, the buffer layer 1Ad can also be disposed under the insulating and thermal-conductivity adhesive 18d and the extended thermal-conductivity layers 17d.

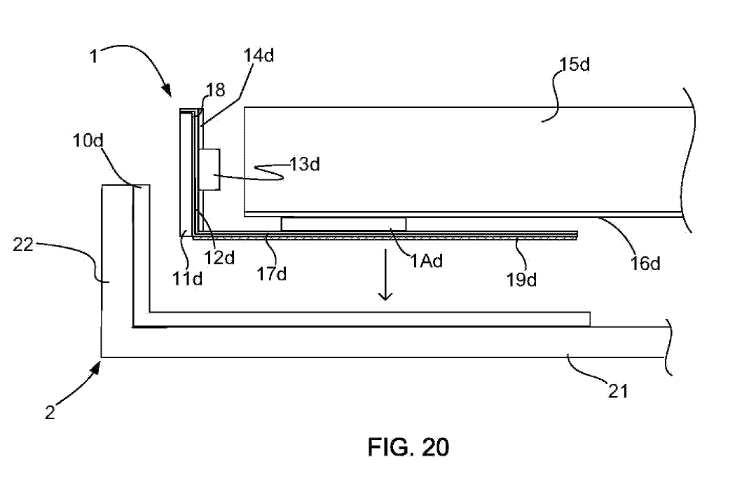

Besides, the supporting member can also be used in the eighth embodiment of the improved LED backlight module. Please refer to FIG. 20, which illustrates a second side view of the eighth embodiment of the improved LED backlight module according to the present invention. In FIG. 20, one supporting member 19d is disposed under the thermal-conductivity adhesive 18d and the extended thermal-conductivity layers 17d. Besides, the supporting member 19d of the improved LED backlight module illustrated in FIG. 20 can also be disposed on the extended thermal-conductivity layers 17d.

Thus, all embodiments of the improved LED backlight module according to the present invention have been introduced and clearly described; however, the embodiments are not intended to limit scope of the present invention, and all equivalent implementations or alterations within the spirit of the present invention still fall within the scope of the present invention.

I claim:

1. An improved LED backlight module, being disposed on a main frame with a bottom plate, wherein the main frame is installed in a liquid crystal display device, and the improved LED backlight module comprising:
a supporting body, having an inner surface and an outer surface;
a copper circuit layer, being attached to the inner surface of the supporting body via an insulating and thermal-conductivity adhesive, and being further extended to the outer surface of the supporting body, wherein the copper circuit layer comprises a plurality of main circuits, a plurality of soldering points and an electrically connecting portion;
a plurality of LED chips, being disposed on the copper circuit layer and welded to the plurality of soldering points;
a plurality of extended thermal-conductivity layers, being connected with the soldering points, wherein a minority of the extended thermal-conductivity layers are attached to the inner surface of the supporting body and a majority of the extended thermal-conductivity layers are horizontally extended from the inner surface of the supporting body for being attached to the surface of the bottom plate of the main frame through the insulating and thermal-conductivity adhesive;
a light guide plate, being opposite to the LED chips by a light-incident surface thereof for receiving light emitted by the LED chips; and
a bottom reflecting member, being attached to the bottom surface of the light guide plate and used for preventing from the light leakage;
wherein when the LED chips emit the light, the soldering points conducting the heat produced by the LED chips to the extended thermal-conductivity layers, so as to evenly distribute the heat over the surface of the bottom plate.

2. The improved LED backlight module of claim 1, further comprising a reflecting layer, being opposite to the LED chips and disposed on the copper circuit layer, wherein the reflecting layer has a plurality of through holes for being passed by the plurality of LED chips, respectively.

3. The improved LED backlight module of claim 2, further comprising an extruded body, being disposed on the main frame and used for accommodating the supporting body, the copper circuit layer and the LED chips.

4. The improved LED backlight module of claim 1, wherein the manufacturing material of the supporting body is selected from the group consisting of: metal and fiberglass.

5. The improved LED backlight module of claim 4, wherein the appearance shape of the supporting body is selected from the group consisting of: “ [symbol] ” shape, “L ” shape and “l” shape.

6. The improved LED backlight module of claim 1, wherein the electrically connecting portion of the copper circuit layer is used for electrically connecting to a circuit controlling unit installed in the liquid crystal display device.

7. The improved LED backlight module of claim 2, wherein the appearance shape of the reflecting layer is selected from the group consisting of: “ [symbol] ” shape, “L” shape and “l” shape.

8. The improved LED backlight module of claim 1, wherein the partial main circuits of the copper circuit layer can be made to lacquered wires.

9. The improved LED backlight module of claim 3, wherein the extruded body can be replaced by a sheet metal member.

10. An improved LED backlight module, being disposed on a main frame with a bottom plate and an edge, wherein the main frame is installed in a liquid crystal display device, and the improved LED backlight module comprising:
a supporting body, being disposed on the edge of the main frame;
a supporting member, being disposed on the bottom plate of the main frame and connected to the supporting body, and having an inner surface and an outer surface;
a copper circuit layer, being attached to the inner surface of the supporting member via a first insulating and thermal-conductivity adhesive, and being extended to the outer surface of the supporting member, wherein the copper circuit layer comprises a plurality of main circuits, a plurality of soldering points and an electrically connecting portion;
a plurality of LED chips, being disposed on the copper circuit layer and welded to the plurality of soldering points;
a plurality of extended thermal-conductivity layers, being connected with the soldering points, wherein the extended thermal-conductivity layers are attached to the inner surface of the supporting member through the first insulating and thermal-conductivity adhesive;
a light guide plate, being opposite to the LED chips by a light-incident surface thereof for receiving light emitted by the LED chips; and
a bottom reflecting member, being attached to the bottom surface of the light guide plate and used for preventing from the light leakage;
wherein when the LED chips emit the light, the soldering points conducting the heat produced by the LED chips to the extended thermal-conductivity layers, so as to evenly distribute the heat over the surface of the bottom plate via the supporting member.

11. The improved LED backlight module of claim 10, further comprising a reflecting layer, being opposite to the LED chips and disposed on the copper circuit layer, wherein the reflecting layer has a plurality of through holes for being passed by the plurality of LED chips, respectively.

12. The improved LED backlight module of claim 11, further comprising an extruded body, being disposed on the main frame and used for accommodating the supporting body, the supporting member, the copper circuit layer and the LED chips.

13. The improved LED backlight module of claim 10, wherein the manufacturing material of the supporting body is selected from the group consisting of: metal and fiberglass.

14. The improved LED backlight module of claim 13, wherein the manufacturing material of the supporting member is selected from the group consisting of: metal and plastic.

15. The improved LED backlight module of claim 14, wherein the supporting member is connected to the supporting body through a thermal-conductivity adhesive when the manufacturing material of the supporting body is fiberglass.

16. The improved LED backlight module of claim 14, wherein the supporting member is connected to the supporting body through a second insulating and thermal-conductivity adhesive when both the manufacturing materials of the supporting body and the supporting member are metal.

17. The improved LED backlight module of claim 10, wherein the appearance shape of the supporting body is selected from the group consisting of: “ [symbol] ” shape, “L” shape and “l” shape.

18. The improved LED backlight module of claim 10, wherein the electrically connecting portion of the copper circuit layer is used for electrically connecting to a circuit controlling unit installed in the liquid crystal display device.

19. The improved LED backlight module of claim 11, wherein the appearance shape of the reflecting layer is selected from the group consisting of: “ [symbol] ” shape, “L” shape and “l” shape.

20. The improved LED backlight module of claim 10, wherein the partial main circuits of the copper circuit layer can be made to lacquered wires.

21. The improved LED backlight module of claim 12, wherein the extruded body can be replaced by a sheet metal member.

22. An improved LED backlight module, being disposed on a main frame with a bottom plate, wherein the main frame is installed in a liquid crystal display device, and the improved LED backlight module comprising:
a supporting body, having an inner surface and an outer surface;
a copper circuit layer, being attached to the inner surface of the supporting body via an insulating and thermal-conductivity adhesive, and being extended to the outer surface of the supporting body, wherein the copper circuit layer comprises a plurality of main circuits, a plurality of soldering points and an electrically connecting portion;
a plurality of LED chips, being disposed on the copper circuit layer and welded to the plurality of soldering points;
a plurality of extended thermal-conductivity layers, being connected with the soldering points, wherein a minority of the extended thermal-conductivity layers are attached to the inner surface of the supporting body through the insulating and thermal-conductivity adhesive, and a majority of the extended thermal-conductivity layers being horizontally extended from the inner surface of the supporting body for being attached to the surface of the bottom plate of the main frame through the insulating and thermal-conductivity adhesive;
a supporting member, being connected to the extended thermal-conductivity layers for supporting the extended thermal-conductivity layers;
a light guide plate, being opposite to the LED chips by a light-incident surface thereof for receiving light emitted by the LED chips; and
a bottom reflecting member, being attached to the bottom surface of the light guide plate and used for preventing from the light leakage;
wherein when the LED chips emit the light, the soldering points conducting the heat produced by the LED chips to the extended thermal-conductivity layers, so as to evenly distribute the heat over the surface of the bottom plate through the extended thermal-conductivity layers.

23. The improved LED backlight module of claim 22, further comprising a reflecting layer, being opposite to the LED chips and disposed on the copper circuit layer, wherein the reflecting layer has a plurality of through holes for being passed by the plurality of LED chips, respectively.

24. The improved LED backlight module of claim 23, further comprising an extruded body, being disposed on the main frame and used for accommodating the supporting body, the copper circuit layer, the LED chips, and the supporting member.

25. The improved LED backlight module of claim 22, wherein the manufacturing material of the supporting body is selected from the group consisting of: metal and fiberglass.

26. The improved LED backlight module of claim 25, wherein the appearance shape of the supporting body is selected from the group consisting of: “ [symbol] ” shape, “L” shape and “l” shape.

27. The improved LED backlight module of claim 22, wherein the electrically connecting portion of the copper circuit layer is used for electrically connecting to a circuit controlling unit installed in the liquid crystal display device.

28. The improved LED backlight module of claim 23, wherein the appearance shape of the reflecting layer is selected from the group consisting of: “ [symbol] ” shape, “L” shape and “l” shape.

29. The improved LED backlight module of claim 22, wherein the supporting member is connected to the extended thermal-conductivity layers by way of being disposed on the extended thermal-conductivity layers, and the material of the supporting member being plastic.

30. The improved LED backlight module of claim 22, wherein the supporting member is connected to the extended thermal-conductivity layers by way of being disposed under the extended thermal-conductivity layers, and the material of the supporting member being metal.

31. The improved LED backlight module of claim 22, wherein the partial main circuits of the copper circuit layer can be made to lacquered wires.

32. The improved LED backlight module of claim 24, wherein the extruded body can be replaced by a sheet metal member.

33. An improved LED backlight module, being disposed on a main frame with a bottom plate, wherein the main frame is installed in a liquid crystal display device, and the improved LED backlight module comprising:
a supporting body, having an inner surface, an outer surface and a plurality of passing holes passing through from the inner surface to the outer surface;
a copper circuit layer, being attached to the inner surface of the supporting body via an insulating and thermal-conductivity adhesive, wherein the copper circuit layer comprises a plurality of main circuits, a plurality of soldering points and an electrically connecting portion, moreover, the main circuits being extendedly attached on the outer surface of the supporting body by way of passing through the passing holes;
a plurality of LED chips, being disposed on the copper circuit layer and welded to the plurality of soldering points;
a plurality of extended thermal-conductivity layers, being connected with the soldering points, wherein a minority of the extended thermal-conductivity layers are attached to the inner surface of the supporting body through the insulating and thermal-conductivity adhesive, and a majority of the extended thermal-conductivity layers being horizontally extended from the inner surface of the supporting body for being attached to the surface of the bottom plate of the main frame through the insulating and thermal-conductivity adhesive;
a light guide plate, being opposite to the LED chips by a light-incident surface thereof for receiving light emitted by the LED chips; and
a bottom reflecting member, being attached to the bottom surface of the light guide plate and used for preventing from the light leakage;
wherein when the LED chips emit the light, the soldering points conducting the heat produced by the LED chips to the extended thermal-conductivity layers, so as to evenly distribute the heat over the surface of the bottom plate through the extended thermal-conductivity layers.

34. The improved LED backlight module of claim 33, further comprising a reflecting layer, being opposite to the LED chips and disposed on the copper circuit layer, wherein the reflecting layer has a plurality of through holes for being passed by the plurality of LED chips, respectively.

35. The improved LED backlight module of claim 34, further comprising an extruded body, being disposed on the main frame and used for accommodating the supporting body, the copper circuit layer and the LED chips.

36. The improved LED backlight module of claim 33, wherein the manufacturing material of the supporting body is selected from the group consisting of: metal and fiberglass.

37. The improved LED backlight module of claim 36, wherein the appearance shape of the supporting body is selected from the group consisting of: “ [symbol] ” shape, “L” shape and “l” shape.

38. The improved LED backlight module of claim 33, wherein the electrically connecting portion of the copper circuit layer is used for electrically connecting to a circuit controlling unit installed in the liquid crystal display device.

39. The improved LED backlight module of claim 34, wherein the appearance shape of the reflecting layer is selected from the group consisting of: “ [symbol] ” shape, “L” shape and “l” shape.

40. The improved LED backlight module of claim 34, further comprising a supporting member, being connected to the extended thermal-conductivity layers via the insulating and thermal-conductivity adhesive and used for supporting the extended thermal-conductivity layers.

41. The improved LED backlight module of claim 40, wherein the material of the supporting member is metal.

42. The improved LED backlight module of claim 34, further comprising a supporting member, being disposed on the extended thermal-conductivity layers for supporting the extended thermal-conductivity layers.

43. The improved LED backlight module of claim 42, wherein the material of the supporting member is plastic.

44. The improved LED backlight module of claim 33, wherein the partial main circuits of the copper circuit layer can be made to lacquered wires.

45. The improved LED backlight module of claim 35, wherein the extruded body can be replaced by a sheet metal member.

46. The improved LED backlight module of claim 33, further comprising a buffer layer.
